(19) United States
(12) Patent Application Publication
(10) Pub. No.: US 2026/0093999 A1
(43) Pub. Date: Apr. 2, 2026

(54) EFFICIENT TRAINING OF GENERATIVE REWARD MODEL(S)

(71) Applicant: GOOGLE LLC, Mountain View, CA (US)

(72) Inventors: Aliaksei Severyn, Zurich (CH); Alizée Pace, Zurich (CH); Sebastian Krause, Zurich (CH)

(21) Appl. No.: 19/343,834

(22) Filed: Sep. 29, 2025

Related U.S. Application Data
(60) Provisional application No. 63/701,163, filed on Sep. 30, 2024.

(51) Int. Cl. G06N 3/092

(52) U.S. Cl. CPC G06N 3/092

(57) ABSTRACT

Implementations relate to obtaining input data and responsive output(s), where the responsive output(s) are determined based on processing the input data using a generative model (GM); processing, using a generative reward model (GRM), GRM input to generate corresponding GRM output, where the GRM input includes the responsive output(s); determining, based on the GRM output, a generative verdict, where the generative verdict is indicative of a relative quality of each of the responsive output(s); determining, based on the generative verdict, a reward value; and causing, based on at least the reward value, the GRM to be trained.

### BACKGROUND

Various generative models (GM(s)) have been proposed that can be used to process image content, video content, audio content, natural language (NL) content and/or other input(s), to generate output that reflects generative content that is responsive to the input(s). As one example, multi-modal GM(s) have been developed that can be used to process NL content and/or other input(s) (e.g., image data, video data, and/or audio data), to generate outputs that reflect generative NL content and/or other content (e.g., image data, video data, and/or audio data) that is responsive to the input(s). As another example, large language models (LLM(s)) have been developed that can be used to process NL content and/or other input(s), to generate LLM output that reflects generative NL content and/or other content that is responsive to the input(s). However, current utilizations of GM(s) may suffer from one or more drawbacks.

As one example, GM(s) often require alignment with particular goals or preferences (e.g., successful data analysis, successful action performance, human preferences, etc.) in order to learn to generate meaningful and/or useful outputs. One such method of aligning GM(s) is reinforcement learning based on feedback (e.g., reinforcement learning from human feedback (RLHF)), which can use labelled data (e.g., human labelled data) to learn a reward model for use in reinforcement learning. The success of this approach in aligning GM(s) is strongly dependent on the quality of an underlying reward model.

Generative reward model(s) (GRM(s)) which may generate a text-form analysis of how successful particular response(s) are for a given prompt can be used for aligning GM(s). Training high quality GRM(s) can be reliant on particular training data, e.g., text-form, ground truth data (either human or synthetically generated). However, it can be time-consuming and computationally expensive to collect and store this data, and the collected datasets can exhibit high levels of noise and/or can be limited in size. Moreover, supervised training of GRM(s) through next-token prediction can involve generating a next-token prediction loss based on a comparison between the entire GRM output and the entire corresponding text-form, ground truth data. Not only can this approach be time-consuming and computationally expensive, but it can also fail to appropriately weight and/or prioritize the most important aspects of the text-form, ground truth data, e.g., conclusions contained within the data as to the success of the particular response(s).

### SUMMARY

Implementations disclosed herein are directed to efficient training of generative reward model(s) (GRM(s)). More particularly, but not exclusively, techniques are described herein for training GRM(s) using a reinforcement learning process which leverages binary or otherwise numerically labelled ground truth data. These trained GRM(s) can be used, for example, as part of a fine-tuning process for one or more generative model(s) (GM(s)). In other examples, these trained GRM(s) could be used as or as a component of one or more other inference model(s) and/or one or more evaluation model(s).

In various implementations, input data and one or more responsive outputs may be obtained. The one or more responsive outputs may be determined based on processing the input data using a GM. For example, the GM may be a multi-modal GM. In this example, the input data may include an input prompt and, optionally, also one or more images, one or more portions of video data, and/or one or more portions of audio data, and the corresponding one or more responsive outputs may include one or more images, one or more portions of video data, and/or one or more portions of audio data. In other examples, the GM may be a large language model (LLM). In this example, the input data may include an input prompt, and the one or more responsive outputs may include one or more portions of text data. It will be appreciated that other possible combinations of input data and responsive output(s) are possible.

The input data and corresponding one or more responsive outputs may be obtained via active use of a GM (e.g., by processing the input data using the GM and determining the one or more responsive outputs based on output from the GM). Additionally or alternatively, the input data and corresponding one or more responsive outputs may be obtained from a stored dataset (e.g., where the one or more responsive outputs have previously been determined based on processing of the input data using a GM). In either case, the one or more responsive outputs may be determined based on processing of the input data using a GM.

The GM can be configured for use in processing an input including the input data (referred to herein as the “set of input data” interchangeably), e.g., from a user of a client device, and can be trained for use in processing the input to provide output which is representative of one or more responsive outputs. For example, where the GM is a multi-modal GM, the set of input data could include an input prompt requesting the model to “make this photo of my dog less blurry”. Accompanying this input prompt, the set of input data could also include the particular image (e.g., a photo of their dog) which the user wants to make less blurry. In this instance, the one or more responsive outputs, generated using the GM, could include one or more candidate images (e.g., two candidate images) which attempt to provide a clearer version of the blurry image. As another example, where the GM is an LLM, the input data could include an input prompt requesting the model to “write some C++ code which controls the end effector of my robot to grasp an object”. In this instance, the one or more responsive outputs, generated using the GM, could include one or more candidate portions of C++ code (e.g., two candidate portions of C++ code) which attempt to control an end effector of a robot to grip or otherwise close around an object.

GRM input may be processed, using a GRM, to generate corresponding GRM output. The GRM input may include the one or more responsive outputs. A generative verdict may be determined based on the GRM output. The generative verdict may be indicative of a relative quality of each of the one or more responsive outputs and e.g., may be in text-form. For example, the GRM can be configured for use in processing an input including each of the one or more responsive outputs, e.g., directly from the GM, directly from a stored dataset, or via a client device of a user, and can be trained for use in processing the input to provide output which is representative of a generative verdict. Returning to the one of the examples mentioned above, the GRM may process the two candidate images which attempt to provide a clearer version of the blurry image of a dog. The generative verdict generated by the GRM may be, for example, that “Candidate Image 1 is clearer”, or “Candidate Image 1 is most clear”, or “Candidate Image 1 is clearer than Candidate Image 2”. It will be appreciated that these example generative verdicts are both indicative of a ‘relative’ (e.g., comparative or ranked) quality of each of the one or more responsive outputs. In additional or alternative examples (e.g., where only one responsive output is present), the generative verdict could include a numerical measure (e.g., a number between 0 and 1) indicating the relative quality of the responsive output. Additionally, the generative verdict may also include chain-of-thought reasoning (e.g., “Candidate Image 1 contains more sharp edges than Candidate Image 2”) and/or one or more quality scores which rate the candidate images based on, for example, their success across one or more different categories.

A reward value may be determined based on the generative verdict. Based on at least the reward value, the GRM can be caused to be trained. To determine the reward value, the generative verdict may be compared with a label which provides a ground truth measure of the relative quality of each of the one or more responsive outputs. This label may include binary or otherwise numerically labelled ground truth data which can be compared with the generative verdict. These labels can be obtained from human annotation and/or synthetic generation. Returning to the above example, an image analysis model could analyze the candidate images to determine that Candidate Image 1 is less blurry (according to various possible objective measures) than Candidate Image 2, and a ground truth label could indicate this conclusion. As this conclusion corresponds to the above-described generative verdict (e.g., “Candidate Image 1 is clearer”), a reward value (e.g., 1) which rewards the GRM can be determined. Alternatively, if the ground truth label indicated that Candidate Image 2 is less blurry than Candidate Image 1, a different reward value (e.g., 0) could be determined. It will be appreciated that in additional or alternative examples (e.g., where only one responsive output is present), the ground truth label could include a numerical measure (e.g., a number between 0 and 1) indicating the relative quality of the responsive output, which could be compared to the generative verdict to determine a reward value.

Using the techniques described herein may provide a variety of technical advantages. As context, discriminative reward model(s), which estimate the quality of various responsive output(s) using a numerical score and are trained to minimize classification errors over a binary preference dataset, can be used in aligning GM(s). GRM(s), however, can leverage the many strengths of generative model(s) (e.g., LLM(s)), including performance gains (e.g., ability to produce more accurate generative verdicts) correlated with greater inference-time compute, and performance gains correlated with particular prompting styles (e.g., chain-of-thought prompting, few-shot prompting, etc.). These effects are not seen to the same extent or at all with discriminative (i.e., non-generative) reward models. In other words, GRM(s) can be used to more accurately assess the quality of particular responsive outputs (for example, but not exclusively, by utilizing longer inference time windows, and by prompting them to provide chain-of-thought explanation of their reasoning).

As further context, supervised training of GRM(s) can involve use of a next-token prediction objective which assigns equal weight and/or priority to all parts of a generative verdict generated for training purposes. For example, this form of training can equally weight a portion of a training generative verdict which states that, e.g., “Candidate Image 1 is clearer” and a portion of the training generative verdict which states that, e.g., “Candidate Image 1 shows an image of a dog”. Using a training objective which is equally weighted based on the latter (less important) portion of the training generative verdict, rather than focusing on the former (more important) portion of the training generative verdict, can negatively affect training and/or performance of the GRM(s). By utilizing the training method for GRM(s) described herein, which may involve determining a reward value for a reinforcement learning process, priority can be given to the most important parts of a generative verdict generated for training purposes (e.g., a specific indication of the relative quality of each of the one or more responsive outputs). This can lead to further performance gains (e.g., ability to produce more accurate generative verdicts) for trained GRM(s).

Moreover, supervised training of GRM(s) can involve comparing training generative verdicts to text-form ground truth data (whether human or synthetically generated). This text-form ground truth data can be time-consuming and computationally expensive to collect and store, can exhibit high levels of noise, and/or can be limited in size. Furthermore, this training method can involve generating a next-token prediction loss based on a comparison between the entire training generative verdict and the entire corresponding text-form, ground truth data, which can be time-consuming and computationally expensive. The training method for GRM(s) described herein, which may involve comparing training generative verdicts to binary or otherwise numerically labelled ground truth data can mitigate these effects, and again lead to performance gains (e.g., by increasing the quantity of data on which the GRM(s) can be trained). In other words, it can be quicker and less computationally expensive to collect and store binary or otherwise numerically labelled ground truth data for training GRM(s) compared to text-form ground truth data, and quicker and less computationally expensive to train GRM(s) using this data compared to text-form ground truth data.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some of the implementations disclosed herein can be implemented.

FIG. 2 depicts an overview of an example method for determining reward values for use in training of generative reward model(s) (GRM(s)).

FIG. 3 depicts a flowchart that illustrates an example method for determining reward values for use in training of GRM(s).

FIG. 4 depicts a flowchart that illustrates an example method for training a GRM and, optionally a further generative model (GM).

FIG. 5 depicts an example architecture of a computing device, in accordance with various implementations.

### DETAILED DESCRIPTION

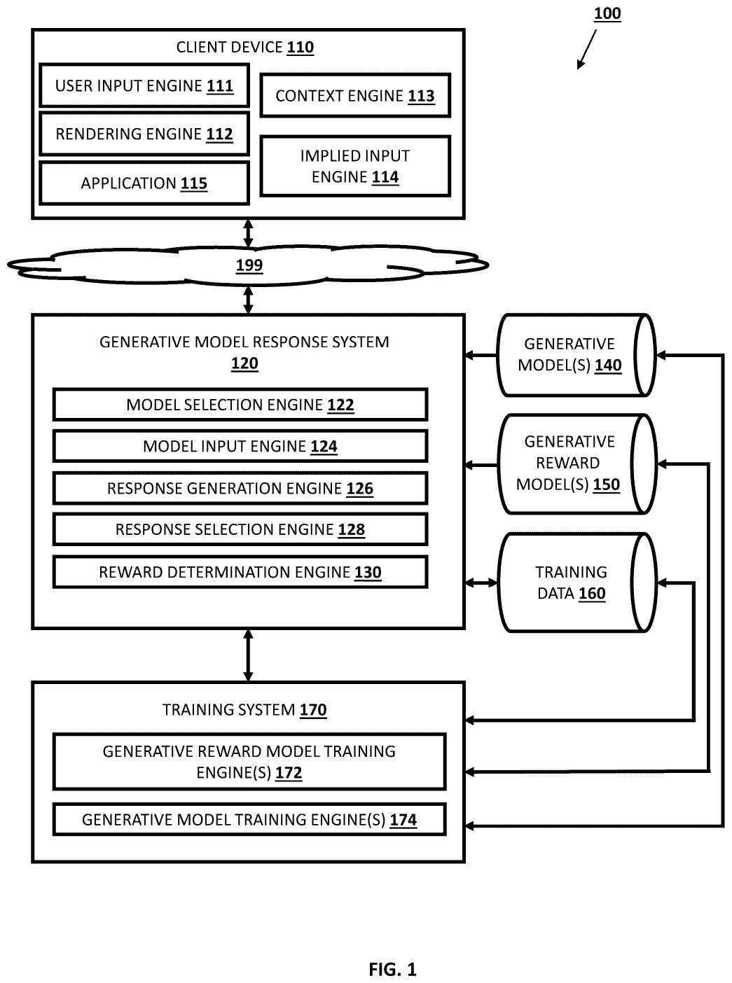

Turning now to FIG. 1, a block diagram of an example environment 100 that demonstrates various aspects of the present disclosure, and in which implementations disclosed herein can be implemented is depicted. The example environment 100 includes a client device 110, a generative model response system 120, and training system 170. Although illustrated separately, in some implementations all or aspects of the generative model response system 120 and all or aspects of the training system 170 can be implemented as part of a cohesive system.

In some implementations, all or aspects of the generative model response system 120 can be implemented locally at the client device 110. In additional or alternative implementations, all or aspects of the generative model response system 120 can be implemented remotely from the client device 110 as depicted in FIG. 1 (e.g., at remote server(s)). In those implementations, the client device 110 and the generative model response system 120 can be communicatively coupled with each other via one or more networks 199, such as one or more wired or wireless local area networks (“LANs”, including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which input data (e.g., the “input data 201” or “set of input data” referred to herein) can be provided and/or selected, and/or other response(s) to the input data (e.g., at least one of the “one or more responsive outputs 202” referred to herein) can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the generative model response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of input data described herein can be input data that is formulated based on user input provided by a user of the client device 110 and detected via user input engine 111. For example, a query can be typed via a physical or virtual keyboard, a suggested query that is selected via a touch screen or a mouse, a spoken voice query that is detected via microphone(s) of the client device, or an image query that is based on an image captured by a vision component of the client device or an image stored in a memory of the client device.

In various implementations, the client device 110 can include a rendering engine 112 that is configured to provide content (e.g., generative content) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided).

Further, the client device 110 and/or the generative model response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

The generative model response system 120 is illustrated as including a model selection engine 122, a model input engine 124, a response generation engine 126, a response selection engine 128, and a reward determination engine 130. Some of the engines can be omitted in various implementations. In some implementations, the engines of the generative model response system are distributed across one or more computing systems and/or the engines of the generative model response system include one or more sub-engines. It will be appreciated that in some implementations, generative model response system 120 may include a generative model response system for use with GM(s) 140 (including any/all of engines 122, 124, 126, 128, and 130), and may include a generative reward model response system for use with GRM(s) 150 (including any/all of engines 122, 124, 126, 128, and 130).

The model selection engine 122 can, in response to receiving a query or other input data, determine which, if any, of multiple generative model(s) 140 (e.g., multi-modal GM(s), LLM(s), image generation model(s), video generation model(s), audio generation model(s), and/or other GM(s)) and/or multiple generative reward model(s) 150 to utilize in generating response(s) responsive to the query/input data. For example, the model selection engine 122 can select none, one, or multiple GM(s) and/or GRM(s) to utilize in generating response(s) responsive to the query/input data. The model selection engine 122 can optionally utilize one or more classifiers and/or rules (not illustrated).

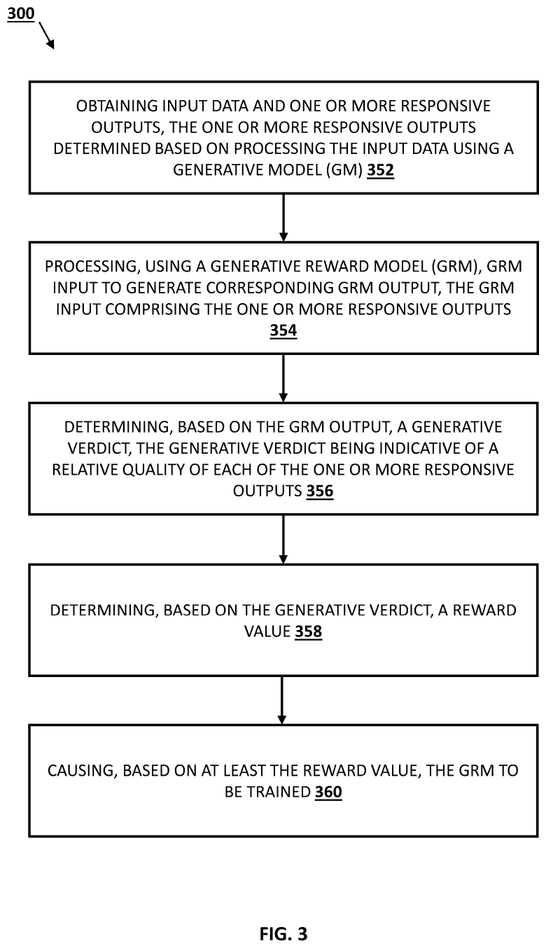

The model input engine 124 can, in response to receiving query/input data, generate model input that is to be processed using GM(s) and/or GRM(s) in generating a response to the query/input data. As described herein, such query/input data (e.g., the “input data 201” or “set of input data” referred to herein, which may be included in “GM input”, and/or the “one or more responsive outputs 202”, which may be included in “GRM input”) can include any combination of input prompt(s), one or more images, one or more portions of video data, one or more portions of audio data, and/or one or more portions of text data. The input data can optionally include additional content, such as contextual information. The model input engine 124 can, for example, reformat input data into a suitable form for processing using GM(s) and/or GRM(s), e.g., reformat an input NL query as a prompt suitable for an LLM, reformat one or more input images into a tensor for input into an image generation model, etc. In various implementations, model input engine 124 can perform all or aspects of block 352 of FIG. 3.

The response generation engine 126 can process input data that is generated by the model input engine 124 using GM(s) and/or GRM(s) (e.g., selected by the model selection engine 122) to generate response/output data. Such response/output data (e.g., the “GM output” or “GRM output” referred to herein) can include a distribution over e.g., a set of potential responsive outputs, a set of potential generative verdicts, etc., based on processing the query/input data using one or more GM(s) and/or GRM(s). In various implementations, response generation engine 126 can perform all or aspects of block 354 of FIG. 3.

The response selection engine 128 can determine, based on the response/output data, content generated using the GM(s) and/or GRM(s) for further use in the methods described herein. Such content (e.g., the “one or more responsive outputs 202” referred to herein, which may be determined from the “GM output”, and/or the “generative verdict” referred to herein, which may be determined from the “GRM output”) can be determined by sampling the distributions described above. In various implementations, response selection engine 128 can perform all or aspects of block 356 of FIG. 3.

The reward determination engine 130 can determine reward value(s) (e.g., “reward value 205” referred to herein) to be associated with the content generated using the GM(s) and/or GRM(s) for further use in the methods described herein. For example, the reward determination engine 130 can determine a reward value based on the “generative verdict” described herein, optionally by comparing the generative verdict, or aspects of the generative verdict to ground truth data, e.g., one or more ground truth labels which could be, optionally, retrieved from training database 160. In various implementations, reward determination engine 130 can perform all or aspects of block 358 of FIG. 3.

The training system 170 is illustrated as including one or more generative reward model (GRM) training engines 172 and one or more generative model (GM) training engines 174. Some of the engines can be omitted in various implementations. Further training engines may also be included in the training system 170.

The GRM training engine(s) 172 can utilize reward value(s) (e.g., determined using reward determination engine 130) to train and/or evaluate one or more of the GRM(s) 150. For example, the GRM training engine(s) 172 can utilize reward values to perform ‘on-policy’ training of GRM(s) via a reinforcement learning process. As another example, the GRM training engine(s) 172 can retrieve reward value(s) (e.g., stored in a reinforcement learning training dataset, optionally stored in training database 160) to perform ‘off-policy’ training of GRM(s) via a reinforcement learning process. In various implementations, GRM training engine(s) 172 can perform all or aspects of block 360 of FIG. 3.

The GM training engine(s) 174 can utilize GRM(s) 150 (e.g., GRM(s) trained using the techniques described herein) and/or further training data to train and/or evaluate one or more of the GM(s) 140. For example, the GM training engine(s) 174 can use a reinforcement learning process to train or fine-tune a GM such that it maximizes expected rewards from a trained GRM. These techniques can increase/improve the alignment of the trained/fine-tuned GM(s) with the underlying data which was used to train the GRM(s).

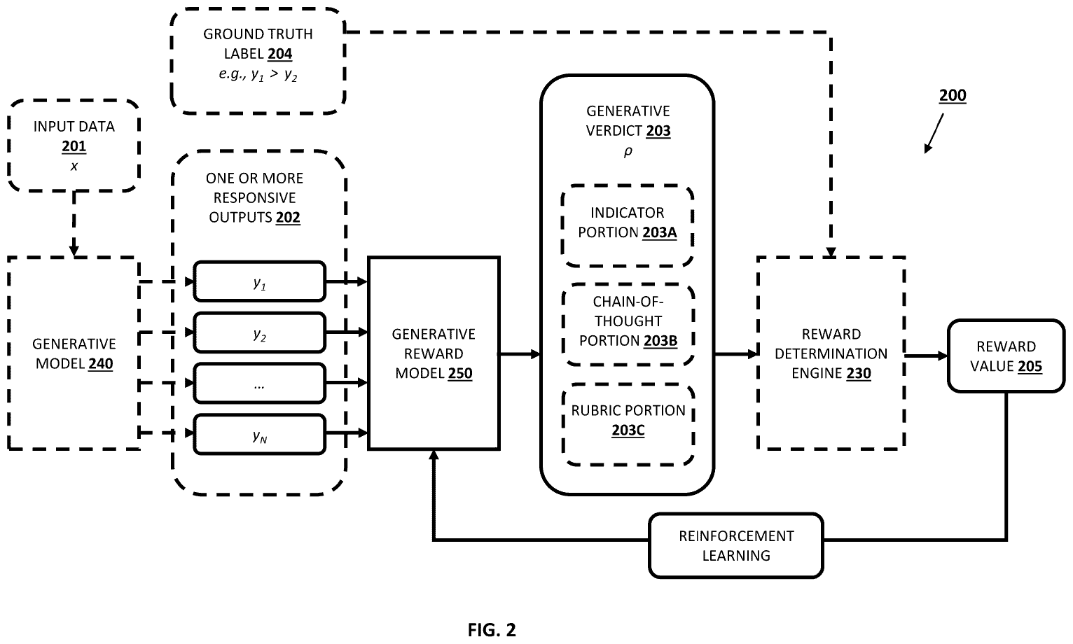

Turning now to FIG. 2, FIG. 2 illustrates an overview of an example method 200 for determining reward values for use in training of GRM(s). As a preliminary step, input data, x, is used as a basis for generating one or more responsive outputs, y₁, y₂, . . . , y_{N}. A generative model (GM) 240 (which may be the same as or similar to one or more of GM(s) 140) is used to process the input data, x, and is trained to generate output representative of the one or more responsive outputs, y₁, y₂, . . . , y_{N}.

The generative model 240 may, in some implementations, be a neural network model. For example, the generative model 240 may comprise one or more of: a convolutional neural network; a variational autoencoder; a recurrent neural network (RNN), such as a long short-term memory (LSTM) network; a transformer-based network; or the like. The generative model 206 may be a generative model trained using generative-adversarial techniques, such as a conditional GAN (cGAN). The generative model 206 may be a stable diffusion model. Many other examples are possible.

The generative model 240, in some examples, generates a probability distribution over a set of potential responsive outputs, e.g., a probability distribution over a set of pixel values, phonemes and/or tokens. The probability distribution may be a conditional probability distribution. The probability distribution can be sampled to generate each responsive output of the one or more responsive outputs.

In some implementations, the generative model 240 is a multi-modal GM which can be configured to process input data in one or more modalities, and can be configured to generate output data in one or more modalities. For example, the input data 201 could include an input prompt (e.g., a natural language input query from a user) e.g., “Make my video of the racing car slow-mo”. In this instance, the input data 201 could also include the video mentioned in the prompt, i.e., a video of a racing car. Based on this input data, the GM 240 can be used to generate one or more responsive outputs. For example, the one or more responsive outputs could include a first candidate slow-motion video of the racing car (i.e., a first responsive output) and a second candidate slow-motion video of the racing car (i.e., a second responsive output). Examples where two responsive outputs are generated may be described herein as “pairwise” examples.

In some implementations, the generative model 240 is a large language model (LLM) configured to process input data which could include an input prompt (e.g., a natural language input query from a user), and can be configured to generate output data (e.g., natural language output). The input data and/or output data can optionally be represented as a sequence of text tokens. For example, an input prompt could be e.g., “Write a piece of C++ code which controls a warehouse robot to follow a white line on the floor”. Based on this input data, the GM 240 can be used to generate one or more responsive outputs. For example, the one or more responsive outputs could include a candidate piece of C++ code (i.e., a first responsive output). Examples where a single candidate responsive output is generated may be described herein as “pointwise” examples.

In some implementations, ground truth data (e.g., a ground truth label 204) which corresponds to the one or more responsive outputs can be generated or otherwise obtained. This ground truth label can indicate some relative (e.g., comparative or ranked) measure of the quality of each of the one or more responsive outputs, y₁, y₂, . . . , y_{N}. In pairwise examples, the ground truth label can indicate, e.g., that y₁>y₂, i.e., y₁ is higher quality than y₂, or that y₁ is the best quality. In pointwise examples, the ground truth label can indicate the relative quality of y₁, e.g., as a number between 0 and 1 (with e.g., 1 indicating the highest possible quality and 0 indicating the lowest possible quality).

Ground truth data/labels can be generated or obtained in a variety of ways. For example, a ground truth label 204 can be synthetically generated. In these examples, one or more models (e.g., generative models, discriminative models, particular specialist evaluation models, etc.) can be used to create a ‘ground truth’ indicator of the relative quality of each of the one or more responsive outputs. Returning to the example above, a video evaluation model may be used to determine that the first candidate slow-motion video of the racing car is higher quality than the second candidate slow-motion video of the racing car (based on any number of possible objective measures, such as the speed of the video, the clarity of the video, and the file size of the video).

As another example, a ground truth label 204 can be human generated. In these examples, one or more human evaluators can create a ‘ground truth’ indicator of the relative quality of each of the one or more responsive outputs. Returning to another example above, a human evaluator or an average of several human evaluators may determine that the single candidate piece of C++ code has a relative quality of 0.8 (based on any number of possible objective measures, such as the structure of the code, the richness of the comments, and the ability of the code to compile).

It will be appreciated that examples with more than two responsive outputs are also possible. For example, in a scenario with three responsive outputs, a ground truth label could indicate that y₁>y₂>y₃, i.e., y₁ is higher quality than y₂, which is in turn higher quality than y₃.

As explained above, the generation of the one or more responsive outputs may be a preliminary step, i.e., one which can be performed separately from the rest of the method illustrated by FIG. 2. For example, input data 201, the corresponding one or more responsive outputs 202 for each set of input data, and optionally a corresponding ground truth label 204 can be stored in a training dataset (optionally stored in training database 160). This training dataset (or at least the one or more responsive outputs) can be obtained for use in the rest of the method illustrated by FIG. 2. In other examples, the generation of the one or more responsive outputs may be a cohesive step, i.e., one performed in combination or in parallel with the rest of the method illustrated by FIG. 2.

A generative reward model (GRM) 250 (which may be the same as or similar to one or more of GRM(s) 150) is used to process the one or more responsive outputs, y₁, y₂, . . . , y_{N}, and is trained to generate output representative of a generative verdict, p. The generative verdict 203 provides some relative (e.g., comparative or ranked) measure of the quality of each of the one or more responsive outputs, y₁, y₂, . . . , y_{N}. This indication may be presented in a natural language format (e.g., “the first candidate slow-motion video of the racing car is higher quality than the second candidate slow-motion video of the racing car”, “the piece of C++ code has a relative quality of 0.7”, etc.), or may be presented in a labelled format (e.g., “y₁>y₂”, “y₁=0.7”, etc.). The generative verdict may also include at least some reasoning or explanation as to why it reached the conclusion represented by the indication of relative quality (e.g., “the first candidate slow-motion video is slowed down to a more appropriate speed”, “the piece of C++ code has lots of helpful comments and compiles, but could be structured better if it used a while loop”). In pairwise examples, the relative indication provided by the generative verdict (e.g., “y₁>y₂” or “y₂>y₁”) can be denoted as binary label, o, where o∈ρ (i.e., such that the binary label, o, can be extracted from the generative verdict, φ.

The generative verdict 203 may include an indicator portion 203A. This portion of the generative verdict may provide the indication of the relative (e.g., comparative or ranked) quality of each of the one or more responsive outputs, y₁, y₂, . . . , y_{N}. Alternatively, this indication may be provided by a portion of the generative verdict other than the indicator portion 203A.

The generative verdict 203 may include a chain-of-thought portion 203B. This portion of the generative verdict may provide the reasoning or explanation as to why it reached the conclusion represented by the indication of relative quality. Alternatively, this reasoning or explanation may be provided by a portion of the generative verdict other than the chain-of-thought portion 203B.

The generative verdict 203 may include a rubric portion 203C. This portion of the generative verdict may provide one or more quality scores that rate the one or more responsive outputs according to certain rubrics and/or categories (e.g., “the first candidate slow-motion video scores: speed 4/5, clarity 3/5, file size 5/5; the second candidate slow-motion video scores: speed 2/5, clarity 1/5, file size 3/5”, “the piece of C++ code scores: structure 2/5, comments 5/5, compiling 5/5”). In the video-based example, the first rubric/category is “speed” (e.g., where a high score is awarded for a video which is an appropriate slow-motion speed), the second rubric/category is “clarity” (e.g., where a high score is awarded for a video which minimizes motion blur), and the third rubric/category is “file size” (e.g., where a high score is awarded for a video which has a lower file size). In the code-based example, the first rubric/category is “structure” (e.g., where a high score is awarded for code which is logically and clearly structure), the second rubric/category is “comments” (e.g., where a high score is awarded for code which is thoroughly commented), and the third rubric/category is “compiling” (e.g., where a high score is awarded for code which compiles without failures or errors).

Prompting the GRM 250 to generate a generative verdict which includes chain-of-thought reasoning or explanation (e.g., as part of chain-of-thought portion 203B) and/or quality scores (e.g., as part of rubric portion 203C) can provide performance gains. Specifically, these prompting styles can improve the ability of the GRM to generate an accurate indication of the relative quality of each of the one or more responsive outputs, for example, an indication which more consistently corresponds to (e.g., is the same as) the indication provided by the ground truth data/label for the one or more responsive outputs. By prompting the GRM 250 in this manner, the final indication can effectively be based on the chain-of-thought reasoning or explanation and/or the quality scores. As such, determining the indicator portion of the generative verdict which provides the indication of the relative quality of each of the one or more responsive outputs can be based on the chain-of-thought portion of the generative verdict and/or can further be based on the rubric portion of the generative verdict.

The generative verdict is used to determine a reward value 205. This determination may be performed, as shown in FIG. 2, by a reward determination engine 230 (which may be the same as or similar to reward determination engine 130). In order to determine a reward value, the indication of relative quality provided by the generative verdict may be compared to some ground truth indicator of relative quality (e.g., ground truth label 204). The methods described herein are generally described with respect to ground truth label 204, but it will be appreciated that a range of ‘ground truth’ comparisons are possible, including techniques based on synthetic evaluation (e.g., evaluation by one or more appropriate models) and human evaluation.

In pairwise examples, discrete, optionally binary, reward values may be employed. For example, if a comparison shows that the relative indication provided by the generative verdict (e.g., “y₁>y₂” or “the first candidate slow-motion video of the racing car is higher quality than the second candidate slow-motion video of the racing car”) corresponds to (e.g., is the same as, or indicates the same conclusion as) the ground truth indication (e.g., “y₁>y₂”), a first reward value can be determined, which may be a reward value of 1. Alternatively, if the relative indication provided by the generative verdict (e.g., “y₂>y₁” or “the second candidate slow-motion video of the racing car is higher quality than the first candidate slow-motion video of the racing car”) does not correspond to (e.g., is not the same as, or does not indicate the same conclusion as) the ground truth indication (e.g., “y₁>y₂”), a second reward value can be determined, which may be a reward value of 0. Such an arrangement can effectively be used to ‘reward’ a GRM for reaching the ‘correct’ conclusion (i.e., one that matches the ground truth label). It will be appreciated that alternative discrete/binary reward values are possible, such as where the first reward value is 0 and the second reward value is 1, where the two reward values are +1 and −1 respectively, etc.

In pointwise examples, continuous reward values (e.g., where each reward value is 0 n 51) may be employed. For example, the reward value can be determined based on a numerical difference/similarity between the relative indication provided by the generative verdict (e.g., “y₁=0.7” or “the piece of C++ code has a relative quality of 0.7”) and the ground truth indication (e.g., “y₁=0.8”). As one particular example, the reward value may be determined as reward=1−|difference|, e.g., reward=1−|0.8−0.7|=0.9. Such an arrangement can effectively be used to ‘reward’ a GRM for reaching or getting close to the ‘correct’ conclusion (i.e., one that matches the ground truth label). It will be appreciated that alternative reward value calculation methods are possible.

It will be appreciated that reward values can be calculated in a same or similar manner for examples with more than two responsive outputs. For example, a ground truth label could indicate that y₁>y₂>y₃, i.e., y₁ is higher quality than y₂, which is in turn higher quality than y₃, and a reward value of 1 could be awarded if the relative indication provided by the generative verdict (e.g., “y₁>y₂>y₃”) corresponds to (e.g., is the same as) the ground truth data, etc.

By using reward values determined in this manner during training of a GRM (e.g., using a reinforcement learning process as described below), the GRM can effectively be taught to improve its own chain-of-thought reasoning, and therefore increase the probability of reaching the ‘correct’ conclusion (i.e., one that matches the ground truth label) without the need for supervised training of the GRM using text-form ground truth data (which can be slower and more computationally expensive). In other words, the methods described herein involve a simple, computationally efficient correspondence comparison between the generative verdict (e.g., an indicator portion of the generative verdict) and ground truth data, as opposed to a slower, computationally expensive text-form comparison necessary for a next-token prediction.

As shown in FIG. 2, the reward value(s) can be used to train GRM(s) using a reinforcement learning process. Whilst the following explanation of the reinforcement learning process of FIG. 2 is given with respect to the pairwise example, it will be appreciated that the process can be adapted for other examples, e.g., pointwise examples. To provide context to the reinforcement learning process, the following explanation begins with an explanation of methods for (a) training discriminative reward models and (b) training generative reward models using a supervised, next-token prediction approach, before discussing (c) an example reinforcement learning objective for training GRM(s).

A dataset can be defined as

$${𝒟}_{HF} = \{ ( {x}^{i} , {y}_{1}^{i} , {y}_{2}^{i} , {o}^{i} ) \} \begin{matrix}N \\ i = 1\end{matrix} ,$$

where x, y₁, y₂, and o are as defined herein, and where o∈{0, 1}, capturing whether y₁ has a higher quality relative quality than y₂.

(a): Pointwise discriminative reward models can take as input a prompt, e.g., a user prompt, and a single response, and output a numerical score. Pointwise discriminative models can be denoted as Re. This framework typically assumes that ground truth labels are determined by the Bradley-Terry model, which maps the ground truth probability to the difference in pointwise reward between two responses:

P_{θ}(o|x,y₁,y₂)=σ(R_{θ}(x,y₁)−R_{θ}(x,y₂)). where α is the sigmoid function.

A reward model can then be estimated from [symbol] _{HF} by minimizing the following binary cross-entropy loss with respect to θ:

$${ℒ}_{disc} ( θ ) = {𝔼}_{( x , {y}_{1} , {y}_{2} , o ) ∼ {𝒟}_{HF}} [ o log {P}_{θ} ( o \vert x , {y}_{1} , {y}_{2} ) + ( 1 - o ) log ( 1 - {P}_{θ} ( o \vert x , {y}_{1} , {y}_{2} ) ) ] . \qquad ( 1 )$$

(b): Generative reward modeling is another modeling framework which leverages language models to generate outputs in text-form (as described herein). One approach is to simply prompt a language model to predict the higher quality of two responses, but the focus herein is on training strategies. Rather than a binary label o for every response pair in [symbol] _{HF}, we now assume access to a natural language rationale ρ comparing the relative quality of the responses. Note that the rationale can contain an indication of relative quality of the responses in text format, usually at the end of a reasoning trace, i.e., o∈ρ.

A generative reward model can be trained by fine-tuning a language model on this new preference dataset

$${𝒟}_{HF}^{text} = \{ ( {x}^{i} , {y}_{1}^{i} , {y}_{2}^{i} , {ρ}^{i} ) ] \begin{matrix}{N}_{text} \\ i = 1\end{matrix} .$$

In particular, fine-tuning of a language model can be carried out through next-token prediction, which minimizes the following objective with respect to θ:

$${ℒ}_{gen , SFT} ( θ ) = - {𝔼}_{( x , {y}_{1} , {y}_{2} , ρ ) ∼ {𝒟}_{HF}^{text}} [ log {P}_{θ} ( ρ \vert x , {y}_{1} , {y}_{2} ) ] \qquad ( 2 )$$

$$= - {𝔼}_{( x , {y}_{1} , {y}_{2} , ρ ) ∼ {𝒟}_{HF}^{text}} [ {\sum }_{t = 1}^{\vert ρ \vert} log {P}_{θ} ( {ρ}_{t} \vert x , {y}_{1} , {y}_{2} , {ρ}_{< t} ) ] . \qquad ( 3 )$$

Here, ρₜ denotes the t-th token in rationale ρ and θ_{θ}(ρₜ|x,y₁,y₂,ρ_{>t}) denotes the likelihood of generating this token given a partial generation up to token t, ρ_{>t}.

(c): Generative reward models can instead be trained using reinforcement learning techniques, as described herein. Synthetic rationales can be defined as \hat{ρ}. The reinforcement learning objective can minimize the following objective with respect to θ:

$${ℒ}_{gen , RL} ( θ ) = - {𝔼}_{( x , {y}_{1} , {y}_{2} , o ) ∼ {𝒟}_{HF} , β ∼ {P}_{θ} ( \text{?} \vert x , {y}_{1} , {y}_{2} )} [ {}_{o ∈ \hat{ρ}} ] + β KL ( {P}_{θ} \vert \vert {P}_{ref} ) ( \text{?} \vert x , {y}_{1} , {y}_{2} ) , \qquad ( 5 )$$

$$\text{?} \text{indicates text missing or illegible when filed}$$

where β is a regularization hyperparameter. This equation formulates a reinforcement learning objective for training the GRM P_{θ} with a pointwise reward function R_{GRM}(m,y₁,y₂,o,\hat{p})= [symbol] _{o∈\hat{p}}. This ‘correctness feedback’ determines whether the generated rationale reaches the ground truth label, and can therefore be seen as equivalent to a ‘final-answer’ reward in LM reasoning efforts.

Turning now to FIG. 3, a flowchart is depicted that illustrates an example method 300 for determining reward values for use in training of GRM(s). The method 300 generally corresponds to the method 200 described in relation to FIG. 2. For convenience, the operations of the method 300 are described with reference to a system that performs the operations. This system of the method 300 includes one or more processors, memory, and/or component(s) of computing device(s). Moreover, while operations of the method 300 are shown in a particular order, this is not meant to be limiting. One or more operations may be reordered, omitted, and/or added.

At block 352, the system obtains input data and one or more responsive outputs, the one or more responsive outputs determined based on processing the input data using a generative model (GM). For example, the input data and one or more responsive outputs can be retrieved from a training dataset (e.g., stored in training database 160). The training dataset may optionally also include ground truth data (e.g., a ground truth label) corresponding to the one or more responsive outputs which indicates a relative quality of each of the responsive outputs (e.g., indicating that the quality of one responsive output is the best and/or numerically scoring the relative quality of the responsive output(s), etc.). In additional or alternative examples, the system can cause the input data to be processed using the GM. The one or more responsive outputs can be determined from the corresponding GM output generated using the GM.

At block 354, the system processes, using a generative reward model (GRM), GRM input to generate corresponding GRM output, the GRM input comprising the one or more responsive outputs. At block 356, the system determines, based on the GRM output, a generative verdict, the generative verdict being indicative of a relative quality of each of the one or more responsive outputs. The indication of the relative quality of each of the one or more responsive outputs may be included in an indicator portion of the generative verdict, which may be determined based, at least in part, on chain-of-thought and/or rubric portions of the generative verdict. Prompting the GRM to generate output representative of generative verdict(s) which include chain-of-thought reasoning/explanation and/or rubric/quality scores can increase the improvements made to the accuracy of the GRM during training.

At block 358, the system determines, based on the generative verdict, a reward value. For example, the relative quality indicated by ground truth data (e.g., a ground truth label) for the one or more responsive outputs can be compared to the relative quality indicated by the generative verdict, and the reward value can be determined based on the result of the comparison.

For example, where the GRM is a pairwise GRM which processes a first responsive output and a second responsive output, the ground truth data (e.g., ground truth label) may correspond to the first responsive output and the second responsive output. Responsive to the result of the comparison being that the relative quality indicated by the ground truth data corresponds to (e.g., is the same as) the relative quality indicated by the generative verdict, the reward value may be determined as a first value, e.g., 1. Responsive to the result of the comparison being that the relative quality indicated by the ground truth data does not correspond to (e.g., is not the same as) the relative quality indicated by the generative verdict, the reward value may be determined as a second value, e.g., 0.

For example, where the GRM is a pointwise GRM which processes a first responsive output, generative verdict may comprise some first numerical measure of the relative quality of the first responsive output, and the ground truth data (e.g., ground truth label) will correspond to the first responsive output and may comprise some second numerical measure of the relative quality of the first responsive output. The reward value can be determined based on comparing this first numerical measure to the second numerical measure and e.g., calculating a reward value (e.g., 0≤n≤1) which is dependent on the difference between them.

At block 360, the system causes, based on at least the reward value, the GRM to be trained. As described herein, the GRM can be trained e.g., using a reinforcement learning process which takes reward value(s) as input. The training of the GRM can be performed directly by the system, or can be performed by one or more other system(s) (e.g., at server(s) remote from the device(s) and system(s) shown in FIG. 1). In additional or alternative examples, the reward value(s) can be stored in a reinforcement learning training dataset (e.g., along with the corresponding input data, one or more responsive outputs, and optionally ground truth data/label). The reinforcement learning training dataset can then be used in training the GRM e.g., using a reinforcement learning process. It will be appreciated that the method described with respect to FIG. 3 can be repeated any number of times to produce a plurality of reward values, which can be used for further training and further improvement of the GRM.

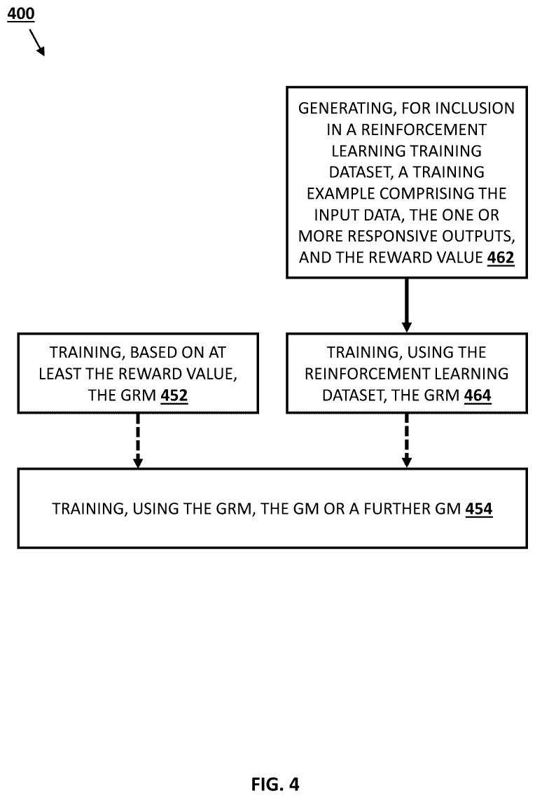

Turning now to FIG. 4, a flowchart is depicted that illustrates an example method 400 for training a GRM and, optionally a further generative model (GM). For convenience, the operations of the method 400 are described with reference to a system that performs the operations. This system of the method 400 includes one or more processors, memory, and/or component(s) of computing device(s). Moreover, while operations of the method 400 are shown in a particular order, this is not meant to be limiting. One or more operations may be reordered, omitted, and/or added.

At block 452, the system trains, based on at least the reward value, the GRM (e.g., the GRM described with reference to FIGS. 2 and 3). For example, the system may use a reinforcement learning process to train the GRM as described herein. Training the GRM may be performed by GRM training engine(s) 172.

At block 454, optionally, the system trains, using the GRM, the GM (e.g., the GM described with reference to FIGS. 2 and 3) or a further GM. For example, the system can train, update, and/or fine-tune the GM or a further GM using the GRM trained at block 452. The GM and/or further GM may be trained using reinforcement learning techniques, utilizing the output of the GRM as a reward signal, where expected rewards are to be maximized. This can result in a GM and/or further GM that is more closely aligned to the ground truth data/labels which have been used to train the GRM. Training the GM and/or further GM may be performed by GM training engine(s) 174.

Instead of, or in parallel with starting at block 452, the method 400 may start at block 462.

At block 462, the system generates, for inclusion in a reinforcement learning training dataset, a training example comprising the input data, the one or more responsive outputs, and the reward value. For example, the system may store one or more training instances (e.g., each training instance including the input data, the one or more responsive outputs, the reward value, and optionally ground truth data/label) in a training dataset (e.g., stored in training database 160).

At block 464, the system trains, using the reinforcement learning dataset, the GRM (e.g., the GRM described with reference to FIGS. 2 and 3). Whilst the techniques described herein generally relate to training the GRM using an ‘on-policy’ reinforcement learning process, it will be appreciated that it is also possible to retrieve previously stored training data (e.g., the reinforcement learning dataset) and use a reinforcement learning process to train the GRM in an ‘off-policy’ manner. Training the GRM may be performed by GRM training engine(s) 172.

At block 454, optionally, the system trains, using the GRM, the GM (e.g., the GM described with reference to FIGS. 2 and 3) or a further GM. For example, the system can train, update, and/or fine-tune the GM or a further GM using the GRM trained at block 464. The GM and/or further GM may be trained using reinforcement learning techniques, utilizing the output of the GRM as a reward signal, where expected rewards are to be maximized. This can result in a GM and/or further GM that is more closely aligned to the ground truth data/labels which have been used to train the GRM. Training the GM and/or further GM may be performed by GM training engine(s) 174.

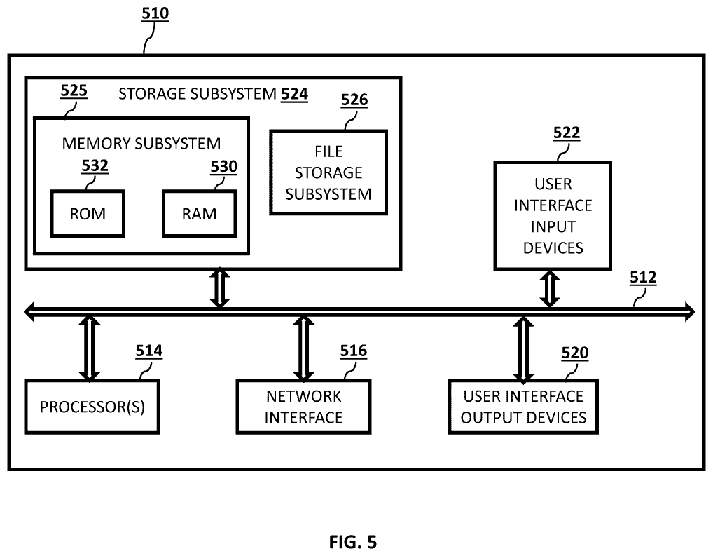

Turning now to FIG. 5, a block diagram of an example computing device 510 that may optionally be utilized to perform one or more aspects of techniques described herein is depicted. In some implementations, one or more of a client device (e.g., client device 110), generative content system component(s) or other cloud-based software application component(s) (e.g., component(s) of generative model response system 120 and/or training engine(s) 170), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein (e.g., as explained with respect to FIGS. 2, 3, and 4), as well as to implement various components depicted in FIGS. 1 and 2.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users (or make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: obtaining input data and one or more responsive outputs, the one or more responsive outputs determined based on processing the input data using a generative model (GM); processing, using a generative reward model (GRM), GRM input to generate corresponding GRM output, the GRM input including the one or more responsive outputs; determining, based on the GRM output, a generative verdict, the generative verdict being indicative of a relative quality of each of the one or more responsive outputs; determining, based on the generative verdict, a reward value; and causing, based on at least the reward value, the GRM to be trained.

These and other implementations of technology disclosed herein can optionally include one or more of the following features.

In some implementations, the GM can be a multi-modal GM.

In some versions of those implementations, the one or more responsive outputs can include one or more images, one or more portions of video data, and/or one or more portions of audio data.

In some additional or alternative implementations, the input data can include a multi-modal input, which can include an input prompt and one or more of: one or more images, one or more portions of video data, and/or one or more portions of audio data.

In some implementations, the GM can be a large language model (LLM).

In some versions of those implementations, the input data can include an input prompt, and the one or more responsive outputs can include one or more portions of text data.

In some additional or alternative implementations, the method can further include: processing, using the GM, GM input to generate corresponding GM output, where the GM input can include the input data; and determining, based on the GM output, the one or more responsive outputs.

In some versions of those implementations, the method can further include: determining, based on the GM output, a distribution over a set of potential responsive outputs; and sampling the one or more responsive outputs from the distribution.

In some additional or alternative implementations, the method can further include: training, based on at least the reward value, the GRM.

In some additional or alternative implementations, the method can further include: generating, for inclusion in a reinforcement learning training dataset, a training example, which can include the input data, the one or more responsive outputs, and the reward value.

In some versions of those implementations, the method can further include: training, using the reinforcement learning training dataset, the GRM.

In some additional or alternative implementations, the method can further include: training, using the GRM, the GM or a further GM.

In some additional or alternative implementations, the method can further include: retrieving a ground truth label corresponding to the one or more responsive outputs, where the ground truth label can be indicative of a relative quality of each of the one or more responsive outputs; comparing the relative quality indicated by the ground truth label to the relative quality indicated by the generative verdict; and determining, further based on a result of the comparison, the reward value.

In some versions of those implementations, comparing the relative quality indicated by the ground truth label to the relative quality indicated by the generative verdict can include: comparing the relative quality indicated by the ground truth label to an indicator portion of the generative verdict which can provide the indication of the relative quality of each of the one or more responsive outputs.

In some versions of those implementations, determining the generative verdict can include: determining, based on the GRM output, a chain-of-thought portion of the generative verdict, where the chain-of-thought portion of the generative verdict can include one or more natural language explanations of the quality of at least one of the one or more responsive outputs; and determining, based on the chain-of-thought portion of the generative verdict, the indicator portion of the generative verdict which can provide the indication of the relative quality of each of the one or more responsive outputs.

In some versions of those implementations, determining the generative verdict can further include: determining, based on the GRM output, a rubric portion of the generative verdict, where the rubric portion of the generative verdict can include one or more quality scores for at least one of the one or more responsive outputs; and determining, further based on the rubric portion of the generative verdict, the indicator portion of the generative verdict which can provide the indication of the relative quality of each of the one or more responsive outputs.

In some versions of those implementations, the one or more quality scores can include one or more quality scores in each of a plurality of categories for each of the one or more responsive outputs.

In some additional or alternative implementations, the ground truth label can be a human generated label.

In some additional or alternative implementations, the ground truth label can be a synthetically generated label.

In some additional or alternative implementations, the GRM can be a pairwise GRM, the one or more responsive outputs can include a first responsive output and a second responsive output, and retrieving the ground truth label can include retrieving a ground truth label corresponding to the first responsive output and the second responsive output, where the ground truth label can be indicative of a relative quality of the first responsive output and the second responsive output, and the method can further include: responsive to the result of the comparison being that the relative quality indicated by the ground truth label corresponds to the relative quality indicated by the generative verdict, determining the reward value to be a first value; and responsive to the result of the comparison being that the relative quality indicated by the ground truth label does not correspond to the relative quality indicated by the generative verdict, determining the reward value to be a second value.

In some versions of those implementations, the first value can be 1 and the second value can be 0.

In some additional or alternative implementations, the GRM can be a pointwise GRM, the one or more responsive outputs can include a first responsive output, the relative quality indicated by the generative verdict can include a first numerical measure of relative quality, and retrieving the ground truth label can include retrieving a ground truth label corresponding to the first responsive output, where the ground truth label can include a second numerical measure of relative quality of the first responsive output, and the method can further include: determining the reward value based on a difference between the first numerical measure and the second numerical measure.

In some versions of those implementations, the reward value can be between 0 and 1.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer-readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
obtaining input data and one or more responsive outputs, the one or more responsive outputs determined based on processing the input data using a generative model (GM);
processing, using a generative reward model (GRM), GRM input to generate corresponding GRM output, the GRM input comprising the one or more responsive outputs;
determining, based on the GRM output, a generative verdict, the generative verdict being indicative of a relative quality of each of the one or more responsive outputs;
determining, based on the generative verdict, a reward value; and
causing, based on at least the reward value, the GRM to be trained.

2. The method of claim 1, wherein the GM is a multi-modal GM, and wherein the one or more responsive outputs comprise one or more images, one or more portions of video data, and/or one or more portions of audio data.

3. The method of claim 2, wherein the input data comprises a multi-modal input comprising an input prompt and one or more of: one or more images, one or more portions of video data, and/or one or more portions of audio data.

4. The method of claim 1, wherein the GM is a large language model (LLM), wherein the input data comprises an input prompt, and wherein the one or more responsive outputs comprise one or more portions of text data.

5. The method of claim 1, further comprising:
processing, using the GM, GM input to generate corresponding GM output, the GM input comprising the input data;
determining, based on the GM output, the one or more responsive outputs.

6. The method of claim 5, further comprising:
determining, based on the GM output, a distribution over a set of potential responsive outputs; and
sampling the one or more responsive outputs from the distribution.

7. The method of claim 6, further comprising:
training, based on at least the reward value, the GRM.

8. The method of claim 1, further comprising:
generating, for inclusion in a reinforcement learning training dataset, a training example comprising the input data, the one or more responsive outputs, and the reward value.

9. The method of claim 8, further comprising,
training, using the reinforcement learning training dataset, the GRM.

10. The method of claim 1, further comprising:
training, using the GRM, the GM or a further GM.

11. The method of claim 1, further comprising:
retrieving a ground truth label corresponding to the one or more responsive outputs, the ground truth label being indicative of a relative quality of each of the one or more responsive outputs;
comparing the relative quality indicated by the ground truth label to the relative quality indicated by the generative verdict; and
determining, further based on a result of the comparison, the reward value.

12. The method of claim 11, wherein comparing the relative quality indicated by the ground truth label to the relative quality indicated by the generative verdict comprises:
comparing the relative quality indicated by the ground truth label to an indicator portion of the generative verdict which provides the indication of the relative quality of each of the one or more responsive outputs.

13. The method of claim 12, wherein determining the generative verdict comprises:
determining, based on the GRM output, a chain-of-thought portion of the generative verdict, the chain-of-thought portion of the generative verdict comprising one or more natural language explanations of the quality of at least one of the one or more responsive outputs; and
determining, based on the chain-of-thought portion of the generative verdict, the indicator portion of the generative verdict which provides the indication of the relative quality of each of the one or more responsive outputs.

14. The method of claim 13, wherein determining the generative verdict further comprises:
determining, based on the GRM output, a rubric portion of the generative verdict, the rubric portion of the generative verdict comprising one or more quality scores for at least one of the one or more responsive outputs; and
determining, further based on the rubric portion of the generative verdict, the indicator portion of the generative verdict which provides the indication of the relative quality of each of the one or more responsive outputs.

15. The method of claim 14, wherein the one or more quality scores comprise one or more quality scores in each of a plurality of categories for each of the one or more responsive outputs.

16. The method of any of claim 11, wherein:
the ground truth label is a human generated label; or
the ground truth label is a synthetically generated label.

17. The method of claim 11, wherein the GRM is a pairwise GRM, wherein the one or more responsive outputs comprise a first responsive output and a second responsive output, and wherein retrieving the ground truth label comprises retrieving a ground truth label corresponding to the first responsive output and the second responsive output, the ground truth label being indicative of a relative quality of the first responsive output and the second responsive output, the method further comprising:
responsive to the result of the comparison being that the relative quality indicated by the ground truth label corresponds to the relative quality indicated by the generative verdict, determining the reward value to be a first value; and
responsive to the result of the comparison being that the relative quality indicated by the ground truth label does not correspond to the relative quality indicated by the generative verdict, determining the reward value to be a second value.

18. The method of claim 17, wherein the first value is 1 and the second value is 0.

19. The method of claim 11, wherein the GRM is a pointwise GRM, wherein the one or more responsive outputs comprise a first responsive output, wherein the relative quality indicated by the generative verdict comprises a first numerical measure of relative quality, and wherein retrieving the ground truth label comprises retrieving a ground truth label corresponding to the first responsive output, the ground truth label comprising a second numerical measure of relative quality of the first responsive output, the method further comprising:
determining the reward value based on a difference between the first numerical measure and the second numerical measure.

20. A system comprising:
at least one processor; and
memory storing instructions that, when executed by the at least one processor, cause the at least one processor to be operable to:
obtain input data and one or more responsive outputs, the one or more responsive outputs determined based on processing the input data using a generative model (GM);
process, using a generative reward model (GRM), GRM input to generate corresponding GRM output, the GRM input comprising the one or more responsive outputs;
determine, based on the GRM output, a generative verdict, the generative verdict being indicative of a relative quality of each of the one or more responsive outputs;
determine, based on the generative verdict, a reward value; and
cause, based on at least the reward value, the GRM to be trained.
